(19) United States
(12) Patent Application Publication
(10) Pub. No.: US 2011/0302056 A1
(43) Pub. Date: Dec. 8, 2011

(54) Wi-Fi Internet Network Ecommerce Redirect Business Process

(76) Inventor: Karl E. Hall, Lewisville, TX (US)

(21) Appl. No.: 12/792,706

(22) Filed: Jun. 2, 2010

(51) Int. Cl. G06Q 30/00

(52) U.S. Cl. 705/27.1

(57) ABSTRACT

This patent describes a business process to redirect Wi-Fi network internet users to online ecommerce site(s) for the purpose of online commerce when users access Wi-Fi internet networks throughout the world.

### CROSS-REFERENCE TO RELATED APPLICATIONS

(Not Applicable)

### STATEMENT REGARDING FEDERALLY SPONSORED RESEARCH OR DEVELOPMENT

(Not Applicable)

### REFERENCE TO SEQUENCE LISTING, A TABLE, OR A COMPUTER PROGRAM LISTING COMPACT DISC APPENDIX

(Not Applicable)

### BACKGROUND OF THE INVENTION

The vast majority of users that access Wi-Fi (Wi-Fi is a trademark of the Wi-Fi Alliance) internet networks in coffee shops, airports, restaurants, hotels, etc. throughout the world decline to purchase internet access on the Wi-Fi internet networks even at relatively low price points. This observable fact results in a significant lost opportunity for Wi-Fi internet service providers to monetize these users when they attempt to access their Wi-Fi internet networks.

### BRIEF SUMMARY OF THE INVENTION

This patent outlines a business process to redirect Wi-Fi network internet users to online ecommerce site(s) for the purpose of online commerce when users access Wi-Fi internet networks throughout the world.

### BRIEF DESCRIPTION OF THE SEVERAL VIEWS OF THE DRAWING

(NOT APPLICABLE)

### DETAILED DESCRIPTION OF THE INVENTION

### Applicability

This business process applies to the following Wi-Fi internet networks:
Wireless Local Area Networks (WLAN);
Wireless Personal Area Networks (WPANs)
Wireless Metropolitan Area Networks (WMAN or WMax)
Wireless Wide Area Networks (WWAM)
Global System for Mobile Communications (GSM)
Personal Communications Service (PCS)
Wireless Broadband
Digital Advanced Mobile Phone Service (D-AMPS)
International Mobile Telecommunications Advanced (IMT Advanced/4G)
International Mobile Telecommunications-2000 (IMT-2000/3G)
All other Wi-Fi internet related networks

This business process will apply to the following computing devices:
Laptop Computers
Mobile telephone devices and smartphones
Tablet personal computers
Netbooks (also called mini notebooks or ultraportables)
Desktop computers
All other computing devices that can access a Wi-Fi internet network

Wi-Fi internet service providers will make their Wi-Fi internet networks available to the general public/users either on a wide area basis or within specific locations such as airports, coffee shops, restaurants, hotels, etc.

Users will access Wi-Fi internet networks via laptop computers, mobile phone devices, tablet computers, personal computers, netbooks, desktop computers or other computing devices.

Users are given a choice to either purchase access to the Wi-Fi internet network or visit and approved ecommerce site(s) for free.

If users decide to visit the approved ecommerce site(s) for free, they will be redirected to the ecommerce site(s).

Wi-Fi internet service providers will provide free access to users while on the ecommerce site(s).

Free internet access will be limited to the designated ecommerce site(s) unless users purchase full internet access from Wi-Fi internet service provider.

The ecommerce site(s) (and or the Wi-Fi internet service providers) will track the purchase activity of re-directed users.

If purchases occur, Wi-Fi internet service providers will receive compensation by the ecommerce site(s) based on a percentage of sales.

Wi-Fi internet service providers and the ecommerce site(s) may also agree to alternative compensation based on the number of users referred to the ecommerce site(s), the amount of time the user spends on the site, or other business metrics.

The holder of this patent will receive 30% of total compensation generated from all Wi-Fi internet service providers that redirect users to ecommerce sites for the purpose of online commerce as patent royalties. These patent royalties will be paid to the patent holder on a monthly basis beginning at the time this business process is implemented by the Wi-Fi internet service providers.

No patent royalty will be paid to the patent holder for new paid Wi-Fi internet network customers obtained as a result of the use of this business process by Wi-Fi internet service providers.

1. This is a unique business process that redirects users of Wi-Fi internet network sites to ecommerce sites for the purpose of online commerce when users access Wi-Fi internet networks throughout the world.

2. This is a unique business process to generate ancillary revenue for Wi-Fi internet service providers by redirecting users to ecommerce site(s) when users access Wi-Fi internet networks throughout the world.

3. This is a unique business process to increase the number of paid users on the full internet networks of Wi-Fi internet service providers by providing limited access to ecommerce site(s) on an introductory/limited basis.
